(19) United States
(12) Patent Application Publication
(10) Pub. No.: US 2013/0130200 A1
(43) Pub. Date: May 23, 2013

(54) Flatbed Dental Implant

(71) Applicant: Milan Djordjevic, Harare (ZW)

(72) Inventor: Milan Djordjevic, Harare (ZW)

(21) Appl. No.: 13/745,400

(22) Filed: Jan. 18, 2013

Related U.S. Application Data
(63) Continuation-in-part of application No. 13/279,047, filed on Oct. 21, 2011.

(51) Int. Cl. A61C 8/00

(52) U.S. Cl. CPC A61C 8/0018
USPC 433/173

(57) ABSTRACT

A flatbed dental implant that includes an open-topped cylindrical body having an ovoid elongate planar portion centrally disposed thereabouts, said planar portion disposed perpendicularly relative the cylindrical body proximal to the open end of said body, and a frustoconical member disposed basally upon the cylindrical body, said frustoconical member having a lip disposed circumferentially about the body, which lip tapers to a cylindrical ring tip enclosing the cylindrical body at a bottom end, wherein the planar portion is osteally engaged when mounted within a shallow subcortical bed incised beneath a mucoperiosteal flap of a jawbone, whereby the flatbed dental implant is securely implanted to support an extant denture therein without risking injury to the inferior aveolar nerve, maxillary sinus, or other endosteal tissue and proximal anatomy as may otherwise occur when incising to a greater depth.

### SPECIFICATION

Be it known that I, Milan Djordjevic, a citizen of the Republic of Serbia, have invented new and useful improvements in a flatbed dental implant as described in this specification. This application claims the prior benefit of my U.S. application Ser. No. 13,279,047 filed on Oct. 21, 2011 and my U.S. Provisional Application No. 61,405,428 filed on Oct. 21, 2010.

### BACKGROUND OF THE INVENTION

Various types of dental implants are known in the prior art. However, what is needed is a flatbed dental implant that includes an open-topped cylindrical body having an ovoid elongate planar portion centrally disposed thereabouts, said planar portion disposed perpendicularly relative the cylindrical body proximal to the open end of said body, and a frustoconical member disposed basally upon the cylindrical body, said frustoconical member having a lip disposed circumferentially about the body, which lip tapers to a cylindrical ring tip enclosing the cylindrical body at a bottom end, wherein the planar portion is osteally engaged when mounted within a shallow subcortical bed incised in a jawbone beneath a mucoperiosteal flap, whereby the flatbed dental implant is securely implanted to support an extant denture therein without risking injury to the inferior aveolar nerve, maxillary sinus, or other osteal tissue, as may otherwise occur when incising to a greater depth.

### FIELD OF THE INVENTION

The present invention relates to a flatbed dental implant, and more particularly, to a flatbed dental implant that includes an open-topped cylindrical body having an ovoid elongate planar portion centrally disposed thereabouts, said planar portion disposed perpendicularly relative the cylindrical body proximal to the open end of said body, and a frustoconical member disposed basally upon the cylindrical body, said frustoconical member having a lip disposed circumferentially about the body, which lip tapers to a cylindrical ring tip enclosing the cylindrical body at a bottom end, wherein the planar portion is osteally engaged when mounted within a shallow subcortical bed incised in a jawbone beneath a mucoperiosteal flap, whereby the flatbed dental implant is securely implanted to support an extant denture therein without risking injury to the inferior aveolar nerve, maxillary sinus, or other osteal tissue, as may otherwise occur when incising to a greater depth.

### SUMMARY OF THE INVENTION

The general purpose of the flatbed dental implant, described subsequently in greater detail, is to provide a flatbed dental implant which has many novel features that result in a flatbed dental implant which is not anticipated, rendered obvious, suggested, or even implied by prior art, either alone or in combination thereof.

The present invention has been devised to enable a dental implant that is securably implanted in a shallow subcortical bed incised beneath a mucoperiosteal flap raised in a jawbone of an applicable patient. The purpose of the present device is to limit the depth of the endosteal incision and thereby avoid injury to the inferior alveolar nerve, for implants effected in the mandible, and alternately the maxillary sinus, for implants in the maxilla. Limiting the intrusion of the implant within a shallow incision of the osteal substrate lessens additional potential harm that may otherwise result to surrounding tissues should a deeper incision or cavity be required.

Heretofore, endosteal dental implants are typically depth stabilized within cavities drilled into the osteal substrate (the maxilla or mandible, as case may be). Typically an elongated body member is positioned within such a cavity and stabilized by osteal engagement across the depth of contact between the body and the osteal cavity. While this method may effectively stabilize a denture to the bone, it can create inadvertent problems from interference with, and injury to, the inferior alveolar nerve (in the mandible) and the maxillary sinus (in the maxilla), as well as to other nerves and endosteal tissue proximal the cavity.

What is needed is a flatbed dental implant that includes a cylindrical body having an elongated planar portion centrally disposed thereupon, said planar portion disposed in a plane perpendicular with the cylindrical body, which planar portion increases the interface between the implant and the osteal substrate horizontally within the bone, rather than vertically thereat, to enable an implant that is secure and stable without the depth of incision otherwise required to secure the body in place absent the planar portion.

The present flatbed dental implant, then, includes an open-ended cylindrical body having a threaded interior and a bottom end. The threaded interior is configured to secure an extant denture therein. A generally ovoid planar portion is centrally disposed upon the cylindrical body more proximal the open end of the body. The planar portion extends transversely therefrom along an axis perpendicular to the height of the cylindrical body. The length of the long axis of the planar portion is greater than the height of the cylindrical body. The length of the short axis of the planar portion is proximal to the exterior diameter of the cylindrical body. To increase the area of osteal and implant interface, and therefore the stability of the device when implanted in an applicable patient's jaw, the planar portion thickens towards each vertex.

A frustoconical member is disposed upon the bottom end of the cylindrical body. The frustoconical member includes a lip disposed circumferentially around the body bottom end, which lip tapers to a cylindrical ring tip that encloses the body bottom end. The frustoconical member anchors the flatbed dental implant into the shallow endosteal bed into which it is positioned.

Thus, a mucoperiosteal flap is raised upon the relevant section of osteal substrate wherein the implant is to be implanted. A cortical bone stripper may be used to prepare a suitable shallow bed to anchor the implant. The planar portion secures the implant in the osteal substrate without the need for extended depth into the particular cortical bone whereby injury to the sinus, associated nerves, and other endosteal tissue and anatomy is minimized. Thus it is envisioned the flatbed dental implant may be secured within a shallow bed that obviates injury, for example, to the inferior alveolar nerve or maxillary sinus, as case may be; injury that may otherwise occur under incisions of a greater depth.

Thus has been broadly outlined the more important features of the present flatbed dental implant so that the detailed description thereof that follows may be better understood and in order that the present contribution to the art may be better appreciated.

Objects of the present flatbed dental implant, along with various novel features that characterize the invention are particularly pointed out in the claims forming a part of this disclosure. For better understanding of the flatbed dental implant, its operating advantages and specific objects attained by its uses, refer to the accompanying drawings and description.

### BRIEF DESCRIPTION OF THE DRAWINGS

### FIGURES

FIG. 1 is an isometric view.

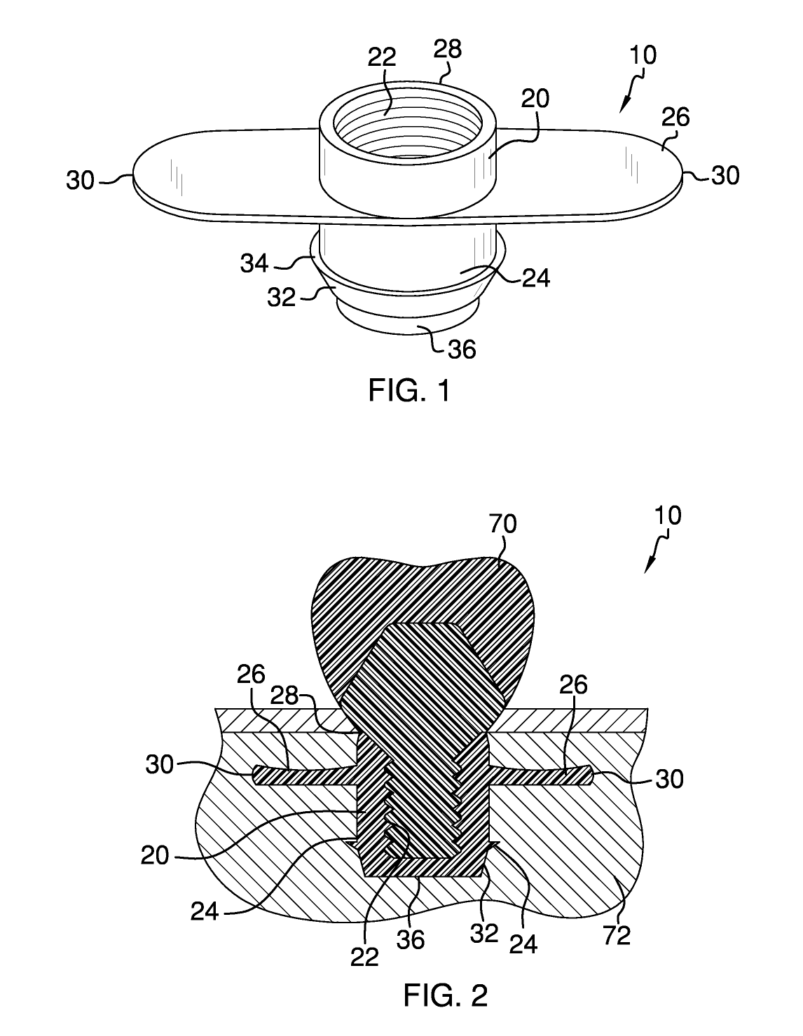

FIG. 2 is a cross-section view taken along the line 2-2 of FIG. 4.

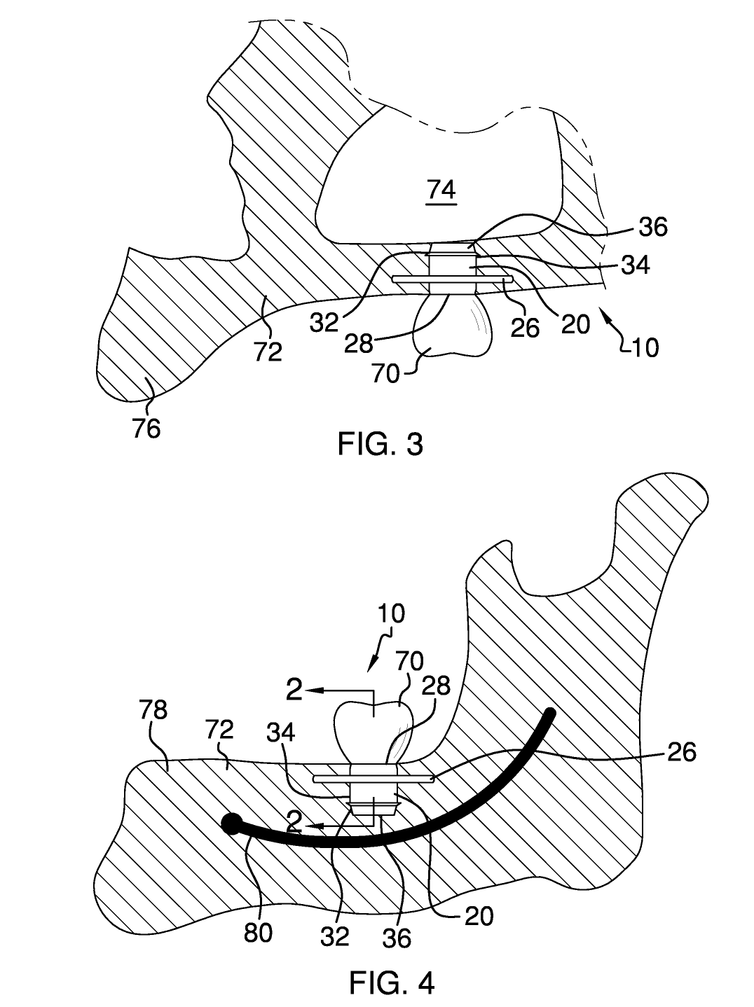

FIG. 3 is a view an in-use view of the flatbed dental implant implanted in a maxilla proximal the maxillary sinus.

FIG. 4 is an in-use view of the flatbed dental implant implanted in a mandible proximal the inferior alveolar nerve.

### DETAILED DESCRIPTION OF THE DRAWINGS

With reference now to the drawings, and in particular FIGS. 1 through 4 thereof, example of the instant flatbed dental implant employing the principles and concepts of the present flatbed dental implant and generally designated by the reference number 10 will be described.

Referring to FIGS. 1 through 4 a preferred embodiment of the present flatbed dental implant 10 is illustrated.

The present flatbed dental implant 10 has been devised to enable secure implantation of a dental implant while minimizing osteal intrusion in the patient's jawbone. The present flatbed dental implant 10 enables endosteal implantation within a shallow bed incised beneath a mucoperiosteal flap, without risk of injuring the inferior alveolar nerve for example, or intruding into the sinus cavity, to prevent lasting discomfort, infection, or loss of feeling in the mandible or maxilla respectively.

The instant flatbed dental implant 10 has been devised for securement within a shallow bed incised beneath a mucoperiosteal flap by means of a planar portion 26 disposed to transversely engage the implant 10 within the jawbone without the need for a deeper cavity otherwise required to support and secure the implant.

The present flatbed dental 10 implant includes an open-topped cylindrical body 20 having a threaded interior 22 and a bottom end 24. The threaded interior 22 is configured to secure an extant denture 70 therein. The planar portion 26 is centrally disposed surrounding the cylindrical body 20, in a plane perpendicular to the height of the cylindrical body 20. The planar portion 26 is disposed more proximal to the body 20 open top 28 than the body 20 bottom end 24.

In the preferred embodiment herein disclosed, the planar portion 26 is an elongate ovoid member, having a long axis greater in length than the height of the cylindrical body 20. The length of the planar portion 26 short axis is proximal to the length of the exterior diameter of the cylindrical body 20. The relative length of the planar portion 26 long axis ensures increased contact area between the implant 10 and the osteal substrate into which it is implanted. As shown in FIG. 2, the planar portion 26 may thicken transversely towards each vertex 30.

A frustoconical member 32 is disposed basally upon the cylindrical body 20. The frustoconical member 32 includes a lip 34 disposed circumferentially around the cylindrical body 20. The frustoconical member 32 tapers toward a cylindrical ring tip 36 disposed to enclose the cylindrical body 20 bottom end 24.

The planar portion 26 and frustoconical member 32 thusly secure endosteal implantation of the flatbed dental implant 10 within a shallow bed incised beneath a mucoperiosteal flap raised in the maxilla 76 (FIG. 3) and alternately the mandible 78 (FIG. 4) of an applicable patient. The depth of incision into the osteal substrate 72 is minimized to avoid injury to the inferior alveolar nerve 80, the maxillary sinus 74, as well as other endosteal tissue and proximal anatomy as may otherwise occur with a deeper endosteal incision (see FIGS. 3 and 4).

In the preferred embodiment herein presented, it is envisioned that the cylindrical body 20 may be manufactured from a hypoallergenic polymer or a nonreactive metal such as titanium or zirconium oxide. Inert precious metals, such as gold and silver, and alloys thereof, are also considered. The planar portion 26 may be manufactured from a hypoallergenic polymer, a metal (such as the cylindrical body), or other material suitable for securing the cylindrical body 20 within a shallow subcortical bed in the jawbone of an applicable patient.

The interior diameter of the cylindrical body 20 is considered to be from between approximately 3 mm and approximately 10 mm, varied to accommodate a particular denture fitted to a particular position within a particular patient's jawbone. The height of the cylindrical body 20 is considered to be in the range of approximately 3 mm to 6 mm, varied to accommodate a particular patient's dentistry, as desired. However, these measurements should not be considered limiting features of the flatbed dental implant 10 here disclosed, and are included only to assist one of ordinary skill in the art in ascertaining the general dimensions the flatbed dental implant 10 might take when manufactured for use.

What is claimed is:

1. A flatbed dental implant comprising:
an open-topped cylindrical body having a threaded interior and a bottom end;
an elongated planar portion centrally disposed surrounding the cylindrical body in a plane perpendicular to the cylindrical body, said planar portion disposed more proximal the open top of the cylindrical body; and
a frustoconical member disposed basally upon the cylindrical body, said frustoconical member including a lip disposed circumferentially around the cylindrical body tapering to a cylindrical ring tip disposed enclosing the cylindrical body bottom end;
wherein the planar portion and frustoconical member secure endosteal implantation of the flatbed dental implant within a shallow subcortical bed incised beneath a mucoperiosteal flap, whereby depth of incision into the osteal substrate is minimized.

2. The flatbed dental implant of claim 1 wherein the planar portion long axis has a length greater than the height of the cylindrical body.

3. The flatbed dental implant of claim 2 wherein the planar portion is generally ovoid.

4. The flatbed dental implant of claim 3 wherein the planar portion transversely thickens towards each vertex.

5. A flatbed dental implant comprising:
an open-topped cylindrical body having a threaded interior and a bottom end;
an ovoid elongated planar portion, having a long axis greater in length than the height of the cylindrical body, disposed surrounding the cylindrical body in a plane perpendicular to the cylindrical body, said planar portion centrally disposed upon the cylindrical body more proximal the open top of the cylindrical body, thereat thickening transversely towards each vertex; and
a frustoconical member disposed basally upon the cylindrical body, said frustoconical member including a lip disposed circumferentially around the cylindrical body tapering to a cylindrical ring tip enclosing the cylindrical body bottom end;
wherein the planar portion and frustoconical member secure endosteal implantation of the flatbed dental implant within a shallow subcortical bed incised beneath a mucoperiosteal flap, whereby depth of incision into the osteal substrate is minimized.
